(19) United States
(12) Patent Application Publication
(10) Pub. No.: US 2025/0163310 A1
(43) Pub. Date: May 22, 2025

(54) HYDRATED SALT COMPOSITE FOR THERMOCHEMICAL HEAT STORAGE, AND PREPARATION METHOD AND USE THEREOF

(71) Applicant: SOUTH CHINA UNIVERSITY OF TECHNOLOGY, Guangzhou, Guangdong (CN)

(72) Inventors: Zhengguo ZHANG, Guangzhou, Guangdong (CN); Shao LIN, Guangzhou, Guangdong (CN); Ziye LING, Guangzhou, Guangdong (CN); Xiaoming FANG, Guangzhou, Guangdong (CN)

(73) Assignees: SOUTH CHINA UNIVERSITY OF TECHNOLOGY, Guangzhou, Guangdong (CN); SOUTH CHINA INSTITUTE OF COLLABORATIVE INNOVATION, Dongguan, Guangdong (CN)

(21) Appl. No.: 18/839,720

(22) PCT Filed: Oct. 31, 2022
(86) PCT No.: PCT/CN2022/128475

§ 371 Date: Aug. 19, 2024

(30) Foreign Application Priority Data
Feb. 28, 2022 (CN) 202210193382.9

(51) Int. Cl. C09K 5/16; H01M 10/659

(52) U.S. Cl. CPC C09K 5/16; H01M 10/659

(57) ABSTRACT

Provided are a hydrated salt composite for thermochemical heat storage, and a preparation method and use thereof. A hydrated salt is compounded with a high-thermal-conductivity material and a reinforcing material to obtain the hydrated salt composite for thermochemical heat storage.

### CROSS REFERENCE TO RELATED APPLICATION

This application is a National Stage under 35 U.S.C. 371 of International Patent Application No. PCT/CN2022/128475, filed Oct. 31, 2022, which claims priority from Chinese Patent Application No. 202210193382.9, filed Feb. 28, 2022; the disclosures of all of which are incorporated herein by reference in their entirety.

### TECHNICAL FIELD

The present disclosure relates to the technical field of thermochemical heat storage and battery thermal runaway and relates to a hydrated salt composite for thermochemical heat storage, and a preparation method and use thereof, where the use relates to a thermochemical heat storage model and an establishment process thereof.

### BACKGROUND

With the large-scale application of lithium-ion batteries and the continuous improvement of lithium-ion battery capacity, lithium-ion battery accidents occur frequently, such as fires due to damaged electric vehicle battery packs and battery module fires in energy storage power stations. When lithium-ion batteries are subjected to thermal abuse, electrical abuse, and mechanical abuse, internal substances continue to decompose and generate heat, causing a battery temperature to continue to rise, thus leading to thermal runaway and the spread of thermal runaway. Some literatures point out that the decomposition of internal materials of batteries is mainly divided into four parts: decomposition of solid electrolyte interface (SEI) film occurring at 70° C. to 120° C., decomposition of negative electrode occurring at 120° C. to 200° C., decomposition of positive electrode occurring at 200° C. to 230° C., and decomposition of electrolyte occurring at 230° C. to 243° C. After a series of reactions, the battery can reach 700° C. or above, which is seriously harmful (Qingsong Wang, et al. A review of lithium-ion battery failure mechanisms and fire prevention strategies [J]. Progress in Energy and Combustion Science, 2019, 73: 95-131). Therefore, it is an important research area to alleviate battery thermal runaway and curb the spread of battery thermal runaway.

Current solution measures can be divided into internal measures and external measures. The internal measures are to improve the stability of battery electrodes, electrolytes, and separators, thereby increasing the temperature critical point of irreversible thermal runaway of the battery, such as micro-encapsulation of electrode materials (Jinyun Liu, et al. A Polysulfides-Confined All-in-One Porous Microcapsule Lithium-Sulfur Battery Cathode [J]. Small, 2021, 17(41), 2103051), addition of flame retardants to electrolytes (L. Kong, et al. Li-ion battery fire hazards and safety strategies [J]. Energies, 2018, 11: 1-11), and selection of ceramic separators or multi-layer separators (C. J. Orendorff, et al. The role of separators in lithium-ion cell safety [J]. Electrochem Soc Interface, 2012, 12: 61-65). However, the above processes are complex and costly, and have no unified measurement standards for a wide variety of battery types as well as poor universality. Moreover, when a battery cell is subjected to mechanical abuse, its structure is damaged, such that the internal measures are not so effective in curbing the spread of thermal runaway after the thermal runaway has occurred. The external measures are to remove the large amount of heat generated by thermal runaway of the battery cell and avoid affecting adjacent batteries as much as possible to prevent the thermal runaway from spreading. The external measures are roughly divided into two types. First is to set an insulation layer between battery cells, such as an aerogel layer, and then remove heat by air cooling or liquid cooling. However, the air cooling can basically not curb the spread of thermal runaway but may promote the spread of thermal runaway (ZHANG Zhihong, MOU Junyan, MENG Yufa. Thermal runaway propagation characteristics of an air-cooled cylindrical lithium-ion battery system [J]. Energy Storage Science and Technology, 2021, 10(02): 658-663). The liquid cooling can alleviate thermal runaway and curb the spread of thermal runaway but requires high-sealing performance of cooling components. In addition, due to the huge heat release of battery thermal runaway, the coolant flow, pump power, and pressure drop may increase rapidly, causing great loss to the liquid cooling components (Xu J, Lan C, et al. Prevent thermal runaway of lithium-ion batteries with minichannel cooling. Applied Thermal Engineering. 2017, 110: 883-90). Moreover, the battery thermal runaway is accompanied by gas injection, which can easily damage the liquid cooling components and cause coolant leakage. Second, low-thermal-conductivity and endothermic phase change materials or high-thermal-conductivity and endothermic phase change materials are filled in battery cells. The thermal runaway and thermal runaway spread are mitigated through the heat storage of a material itself. Basically, the material is a composite of fumed silica or expanded graphite and paraffin phase change materials (Wilke S, Schweitzer B, et al. Preventing thermal runaway propagation in lithium-ion battery packs using a phase change composite material: An experimental study. Journal of Power Sources. 2017; 340: 51-9). This composite exhibits a solid-liquid phase transition temperature of not greater than 50° C., which is much lower than the thermal runaway initial temperature of the battery (120° C.), as well as a phase change latent heat value of 150 J/g, which is much lower than the heat released when the battery is in thermal runaway (about 880 J/g), such that this composite has a common effect of alleviating the spread of thermal runaway. Compared with the air cooling and liquid cooling, filling the endothermic phase change materials in batteries does not require an additional power source and exhibits more convenient in structure, but is necessary to find a material whose phase change temperature matches the initial temperature of thermal runaway and has a higher phase change enthalpy.

Hydrated salt materials can undergo thermal decomposition at high temperatures (around 100° C.), and their crystal water can evaporate and escape, taking away a large amount of heat. Common hydrated salt thermochemical heat storage models are all kinetic models. Their modeling methods all include testing the heating decomposition of materials at different temperature rising rates (such as 5 K/min, 10 K/min, and 15 K/min), and then calculating activation energy, pre-exponential factor and other parameters through the Arrhenius formula. The obtained model parameters are extremely dependent on the material test conditions and have cumbersome calculation. In addition, during the thermal runaway of battery, there is a huge amount of heat released, leading to a high heating rate of the material. The tested heating rate is difficult to match with the actual application scenario. As a result, the obtained thermochemical heat storage model may not be applicable to the actual situation where the material is rapidly heated and decomposed. In view of this, a simpler and more effective thermochemical heat storage model is required to describe the thermochemical heat storage process of hydrated salts.

### SUMMARY

The present disclosure aims to provide a hydrated salt composite for thermochemical heat storage and a preparation method thereof, where the hydrated salt composite has a decomposition temperature relatively matched with an initial temperature of battery thermal runaway and a relatively high decomposition enthalpy, and the hydrated salt composite is filled in battery modules to alleviate thermal runaway and curb spread of the thermal runaway for the battery modules.

In order to achieve the above object, the present disclosure provides the following technical solutions:

The present disclosure provides a hydrated salt composite for thermochemical heat storage, including a high-thermal-conductivity porous adsorption carrier, a hydrated salt heat storage material, and a reinforcing material.

The high-thermal-conductivity porous adsorption carrier serves as a basic supporting skeleton, which provides a heat conduction path and prevents leakage of the hydrated salt.

In some embodiments, the high-thermal-conductivity porous adsorption carrier is one selected from the group consisting of hydrophilically modified expanded graphite, hydrophilically modified silicon nitride, and hydrophilically modified silicon carbide, accounting for 10% to 20% of a total amount of the hydrated salt composite for thermochemical heat storage by mass.

The hydrated salt heat storage material is filled in the carrier to play a role of thermochemical heat storage.

In some embodiments, the hydrated salt heat storage material is a mixed salt of disodium hydrogen phosphate dodecahydrate and sodium acetate trihydrate, with the disodium hydrogen phosphate dodecahydrate accounting for 90% to 98% by mass and the sodium acetate trihydrate accounting for 2% to 10% by mass; and the mixed salt accounts for 70% to 80% of a total amount of the hydrated salt composite for thermochemical heat storage by mass.

The reinforcing material is to enhance a heat conduction path and mechanical properties of the composite after being pressed and formed.

In some embodiments, the reinforcing material is one or more selected from the group consisting of an alumina fiber, an aluminum nitride fiber, a carbon fiber, alumina particles, and a fine graphite powder, accounting for 5% to 10% of a total amount of the hydrated salt composite for thermochemical heat storage by mass.

The present disclosure further provides a method for preparing the hydrated salt composite for thermochemical heat storage mentioned above, including the following steps:
(1) firstly, drying one selected from the group consisting of expanded graphite, a silicon nitride powder, and a silicon carbide powder, then mixing with a surfactant, heating and stirring a resulting mixture in a sealed environment and then secondly, drying to obtain the high-thermal-conductivity porous adsorption carrier for later use;
(2) separately dissolving the disodium hydrogen phosphate dodecahydrate and the sodium acetate trihydrate in water, and mixing resulting solutions, and completely dissolving a resulting mixed solution to obtain the hydrated salt heat storage material for later use;
(3) drying the reinforcing material for later use; and
(4) mixing the high-thermal-conductivity porous adsorption carrier, the hydrated salt heat storage material, and a resulting dried reinforcing material, and heating and stirring a resulting mixture system in a sealed environment, and then cooling and stirring to obtain the hydrated salt composite for thermochemical heat storage.

In some embodiments, the firstly drying and the secondly drying in step (1) each are independently conducted at a temperature of 100° C. to 120° C. for 24 h to 48 h.

In some embodiments, the surfactant in step (1) is one selected from the group consisting of polyethylene glycol sorbitan monostearate (Tween 60, CAS: 9005-67-8) and polyoxyethylene octylphenyl ether (Triton X-100).

In some embodiments, the heating and stirring in step (1) is conducted at a temperature of 60° C. to 70° C. for 1 h to 3 h.

In some embodiments, the completely dissolving in step (2) is conducted at a temperature of 60° C. to 70° C.

In some embodiments, the drying in step (3) is conducted at a temperature of 100° C. to 120° C. for 24 h to 48 h.

In some embodiments, the heating and stirring in step (4) is conducted at a temperature of 60° C. to 70° C. for 4 h to 6 h, and
the cooling and stirring in step (4) is conducted at a temperature of 10° C. to 20° C. for 1 h to 2 h.

The present disclosure further provides use of the hydrated salt composite for thermochemical heat storage mentioned above in battery thermal runaway protection.

In addition, the present disclosure further provides a simple and effective hydrated salt thermochemical heat storage model. The hydrated salt thermochemical heat storage model is constructed to describe a thermochemical heat storage process of the hydrated salt composite for thermochemical heat storage, so as to optimize a dosage of the hydrated salt composite for thermochemical heat storage in a module and estimate a temperature in the case of thermal runaway of a battery.

The hydrated salt thermochemical heat storage model is a lumped model, which combines sensible heat and latent heat of a material into an apparent specific heat capacity and regards the thermochemical heat storage process as a quasi-linear process related to an initial temperature, a final temperature, a decomposition enthalpy, and a real-time temperature of thermochemical decomposition.

### Beneficial Effects

Compared with the prior art, some embodiments of the present disclosure have the following advantages and beneficial effects.
(1) The hydrated salt composite for thermochemical heat storage has a latent heat value of 110 J/g to 150 J/g at 34° C. to 60° C. and a decomposition enthalpy of 1,100 J/g to 1,300 J/g at 85° C. to 110° C.; and the decomposition temperature and the decomposition enthalpy are both relatively consistent with an initial temperature of the battery thermal runaway and a unit heat release during the thermal runaway.
(2) The hydrated salt composite for thermochemical heat storage can be filled in a battery module to effectively alleviate thermal runaway of a battery and curb spread of the thermal runaway when the battery is subjected to electrical abuse, mechanical abuse, and thermal abuse and then the thermal runaway occurs.
(3) The hydrated salt composite for thermochemical heat storage has a thermal conductivity of (6.26-14.56) W/(m·K) at a density of (6,00-1,000) kg/m³ and a high compressive strength.
(4) A relative error between simulation results of the hydrated salt thermochemical heat storage model and an experiment does not exceed 5%. The model can accurately describe the heat storage capacity of a material and is simpler and more effective than a complex kinetic model commonly used to describe thermochemical processes.

### BRIEF DESCRIPTION OF THE DRAWINGS

FIG. 1 shows a differential scanning calorimetry-thermogravimetric analysis (DSC-TG) graph of the hydrated salt composite for thermochemical heat storage obtained in Example 1;

FIG. 2 is a diagram showing the thermal conductivity of the hydrated salt composite for thermochemical heat storage obtained in Example 1 at different densities;

FIG. 3 is a diagram showing the compressive strength of the hydrated salt composite for thermochemical heat storage obtained in Example 1;

FIG. 4 is a diagram showing the modeling process of the hydrated salt thermochemical heat storage model according to an embodiment of the present disclosure; and

FIG. 5 shows an actual temperature curve in a battery module and a simulated temperature curve predicted by the hydrated salt thermochemical heat storage model for the hydrated salt composite for thermochemical heat storage obtained in Example 1.

### DETAILED DESCRIPTION OF THE EMBODIMENTS

### Example 1

(1) 100 meshes expanded graphite was dried in an oven at 120° C. for 24 h to remove the moisture adsorbed from air. The expanded graphite and Tween 60 were mixed in a sealed stirring kettle at a mass ratio of 96:4 and stirred at 60° C. for 3 h, where the Tween 60 was dissolved in pure water in advance and a resulting aqueous solution containing Tween 60 was ensured to completely wet the expanded graphite. Then, a resulting modified expanded graphite was dried in an oven at 120° C. for 24 h to remove the modifier to obtain hydrophilically modified expanded graphite.
(2) Disodium hydrogen phosphate dodecahydrate and sodium acetate trihydrate were mixed at a mass ratio of 97:3 and completely dissolved in an oven at 65° C. to obtain a mixed salt. An alumina fiber cut into small pieces was dried in an oven at 120° C. for 24 h.
(3) The hydrophilically modified expanded graphite, the mixed salt, and a resulting dried alumina fiber were mixed in a sealed stirring kettle at a mass ratio of 20:70:10 and stirred at 70° C. for 4 h under sealing, and then stirred at 10° C. for 1 h to obtain a hydrated salt composite for thermochemical heat storage.

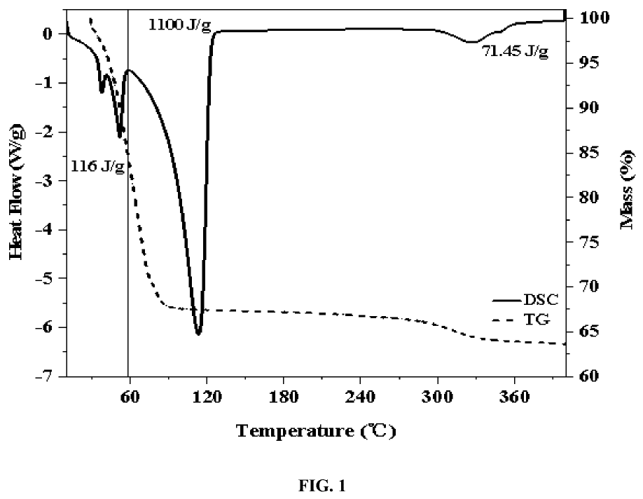

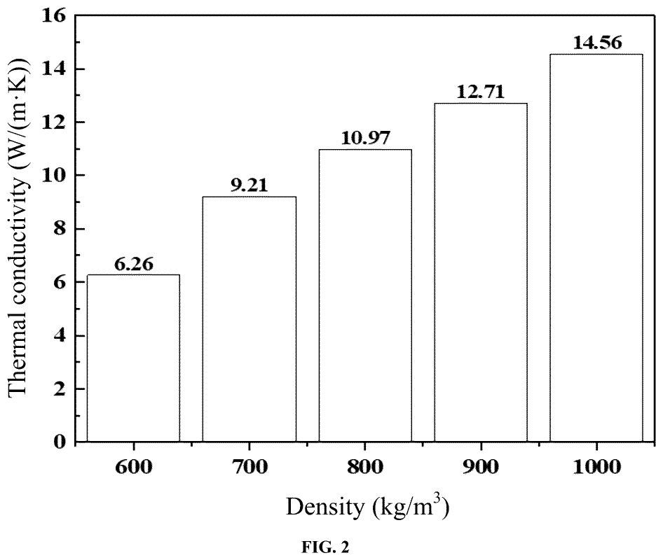

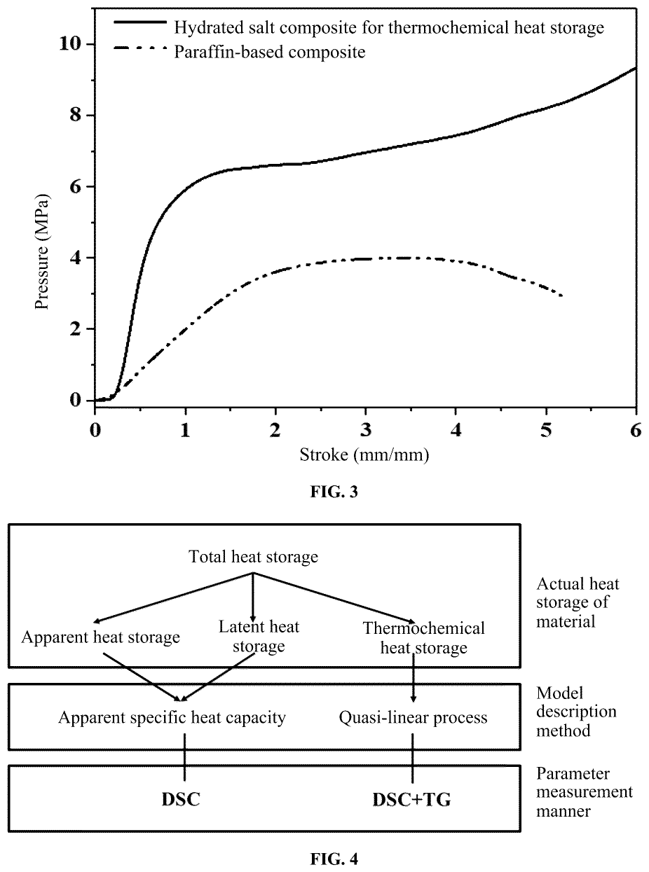

FIG. 1 shows a DSC-TG graph of the hydrated salt composite for thermochemical heat storage obtained in Example 1; where the hydrated salt composite for thermochemical heat storage has a latent heat value of 116 J/g at 34° C. to 60° C. and a decomposition enthalpy of 1,100 J/g at 85° C. to 110° C. FIG. 2 is a diagram showing the thermal conductivity of the hydrated salt composite for thermochemical heat storage obtained in Example 1. As shown in FIG. 2, the hydrated salt composite for thermochemical heat storage has thermal conductivities of 6.26 W/(m·K), 9.21 W/(m·K), 10.97 W/(m·K), 12.71 W/(m·K), and 14.56 W/(m·K) at densities of 600 kg/m³, 700 kg/m³, 800 kg/m³, 900 kg/m³, and 1,000 kg/m³, respectively, and could quickly conduct heat to the entire module to avoid heat accumulation. FIG. 3 is a diagram showing the compressive strength of the hydrated salt composite for thermochemical heat storage obtained in Example 1. As shown in FIG. 3, compared with paraffin-based endothermic materials, the hydrated salt composite for thermochemical heat storage has better compressive resistance, could effectively resist a pressure shock generated when the battery is out of control, thus avoiding serious damage to the entire material.

### Example 2

(1) 50 meshes expanded graphite was dried in an oven at 100° C. for 48 h to remove the moisture adsorbed from air. The expanded graphite and Triton X-100 were mixed in a sealed stirring kettle at a mass ratio of 96:4 and stirred at 65° C. for 2 h, where the Triton X-100 was dissolved in pure water in advance and a resulting aqueous solution containing Triton X-100 was ensured to completely wet the expanded graphite. Then, a resulting modified expanded graphite was dried in an oven at 110° C. for 36 h to remove the modifier to obtain hydrophilically modified expanded graphite.
(2) Disodium hydrogen phosphate dodecahydrate and sodium acetate trihydrate were mixed at a mass ratio of 90:10 and completely dissolved in an oven at 70° C. to obtain a mixed salt. An aluminum nitride fiber cut into small pieces was dried in an oven at 110° C. for 36 h.
(3) The hydrophilically modified expanded graphite, the mixed salt, and a resulting dried aluminum nitride fiber were mixed in a sealed stirring kettle at a mass ratio of 10:80:10 and stirred at 65° C. for 5 h under sealing, and then stirred at 15° C. for 1.5 h to obtain a hydrated salt composite for thermochemical heat storage.

The hydrated salt composite for thermochemical heat storage obtained in this example has a latent heat value of 132 J/g at 34° C. to 60° C. and a decomposition enthalpy of 1,250 J/g at 85° C. to 110° C.; the DSC-TG graph of the hydrated salt composite in Example 2 is similar to FIG. 1; and the thermal conductivity of the hydrated salt composite in Example 2 is similar to that in Example 1.

### Example 3

(1) A silicon carbide powder was dried in an oven at 110° C. for 36 h to remove the moisture adsorbed from air. The silicon carbide powder and Tween 60 were mixed in a sealed stirring kettle at a mass ratio of 96:4 and stirred at 70° C. for 1 h, where the Tween 60 was dissolved in pure water in advance and a resulting aqueous solution containing Tween 60 was ensured to completely wet the silicon carbide powder. Then, a resulting modified silicon carbide powder was dried in an oven at 100° C. for 48 h to remove the modifier to obtain a hydrophilically modified silicon carbide powder.
(2) Disodium hydrogen phosphate dodecahydrate and sodium acetate trihydrate were mixed at a mass ratio of 98:2 and completely dissolved in an oven at 60° C. to obtain a mixed salt. An alumina fiber cut into small pieces was dried in an oven at 100° C. for 48 h.
(3) The hydrophilically modified silicon carbide powder, the mixed salt, and a resulting dried alumina fiber were mixed in a sealed stirring kettle at a mass ratio of 15:80:5 and stirred at 60° C. for 6 h under sealing, and then stirred at 20° C. for 2 h to obtain a hydrated salt composite for thermochemical heat storage.

The hydrated salt composite for thermochemical heat storage obtained in this example has a latent heat value of 130 J/g at 34° C. to 60° C. and a decomposition enthalpy of 1,230 J/g at 85° C. to 100° C.; the DSC-TG graph of the hydrated salt composite in Example 3 is similar to FIG. 1; and the thermal conductivity of the hydrated salt composite in Example 3 is similar to that in Example 1.

### Example 4

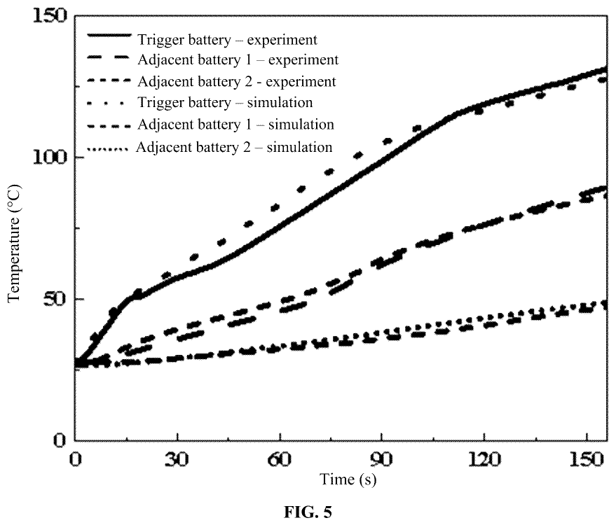

The hydrated salt composite for thermochemical heat storage obtained in Example 1 was pressed into a block with a length, width and height of 125 mm*110 mm*57 mm at a density of 600 kg/m³, and a total of 20 (4*5) complete holes with a diameter of 18 mm are distributed in the block, and a hole spacing is 7 mm. 18650 batteries with a diameter of 18 mm and a height of 65 mm were placed in the holes. The batteries were triggered to undergo thermal runaway, as shown in FIG. 5, with a maximum temperature of about 130° C., far below 700° C., and temperatures between adjacent batteries (adjacent heating rods) are all below 100° C., indicating that the hydrated salt composite for thermochemical heat storage could effectively alleviate battery thermal runaway and inhibit the spread of thermal runaway.

FIG. 4 is a diagram showing the modeling process of the hydrated salt thermochemical heat storage model, where the total heat storage consists of sensible heat storage, latent heat storage, and thermochemical heat storage. The thermochemical heat storage process is regarded as a quasi-linear process, which is only related to the initial temperature, final temperature, decomposition enthalpy, and real-time temperature of decomposition. The latent heat storage and the sensible heat storage are combined into an apparent specific heat capacity. The hydrated salt composite for thermochemical heat storage obtained in Example 1 was subjected to TG-DSC testing, and its decomposition initial temperature is 85° C., decomposition final temperature is 110° C., and decomposition enthalpy is 1,100 J/g; according to the modeling process diagram of FIG. 4, a mathematical expression of its thermochemical decomposition process is:

$$\frac{T - 85}{110 - 85} * 1100$$

wherein T represents the real-time temperature of a material.

The temperature curve predicted by the model is shown in FIG. 5, and is highly consistent with the actual temperature curve, indicating that the modeling method could effectively predict the temperature changes of batteries and materials, and is reliable and simple.

A block of the hydrated salt composite for thermochemical heat storage obtained in Example 1 was optimized by the model established according to FIG. 4. At a compaction density of 600 kg/m³, 100 modules with 18650 batteries were placed, and the hydrated salt composite for thermochemical heat storage was filled in the batteries while shortening the battery spacing to 3 mm. By optimizing the dosage of hydrated salt composite for thermochemical heat storage in the module through this model, it could still be ensured that the temperature is around 140° C. for triggering battery thermal runaway and the temperature is not higher than 100° C. surrounding battery.

The above examples are to explain the present disclosure. However, the embodiments of the present disclosure are not limited by the above examples. Any change, modification, substitution, combination and simplification made without departing from the spiritual essence and principle of the present disclosure should be an equivalent replacement manner, and all are included in the scope of the present disclosure.

1. A hydrated salt composite for thermochemical heat storage, comprising:
a thermal-conductivity porous adsorption carrier,
a hydrated salt heat storage material; and
a reinforcing material.

2. The hydrated salt composite for thermochemical heat storage according to claim 1, wherein the thermal-conductivity porous adsorption carrier is one selected from the group consisting of hydrophilically modified expanded graphite, hydrophilically modified silicon nitride, and hydrophilically modified silicon carbide.

3. The hydrated salt composite for thermochemical heat storage according to claim 1, wherein the hydrated salt heat storage material is a mixed salt of disodium hydrogen phosphate dodecahydrate and sodium acetate trihydrate, with the disodium hydrogen phosphate dodecahydrate accounting for 90% to 98% by mass and the sodium acetate trihydrate accounting for 2% to 10% by mass.

4. The hydrated salt composite for thermochemical heat storage according to claim 1, wherein the reinforcing material is one or more selected from the group consisting of a carbon fiber, an alumina fiber, an aluminum nitride fiber, alumina particles, and a graphite powder.

5. A method for preparing the hydrated salt composite for thermochemical heat storage according to claim 1, comprising the following steps:
(1) firstly drying one selected from the group consisting of expanded graphite, a silicon nitride powder, and a silicon carbide powder, then mixing with a surfactant, heating and stirring a resulting mixture in a sealed environment, and then secondly drying to obtain the thermal-conductivity porous adsorption carrier;
(2) separately dissolving the disodium hydrogen phosphate dodecahydrate and the sodium acetate trihydrate in water, and mixing resulting solutions, and completely dissolving a resulting mixed solution to obtain the hydrated salt heat storage material;
(3) drying the reinforcing material; and
(4) mixing the thermal-conductivity porous adsorption carrier, the hydrated salt heat storage material, and a resulting dried reinforcing material, and heating and stirring a resulting mixture system in a sealed environment, and then cooling and stirring to obtain the hydrated salt composite for thermochemical heat storage.

6. The method for preparing the hydrated salt composite for thermochemical heat storage according to claim 5, wherein the firstly drying and the secondly drying in step (1) each are independently conducted at a temperature of 100° C. to 120° C. for 24 h to 48 h
the surfactant in step (1) is one selected from the group consisting of polyethylene glycol sorbitan monostearate and polyoxyethylene octylphenyl ether, and
the heating and stirring in step (1) is conducted at a temperature of 60° C. to 70° C. for 1 h to 3 h.

7. The method for preparing the hydrated salt composite for thermochemical heat storage according to claim 5, wherein the completely dissolving in step (2) is conducted at a temperature of 60° C. to 70° C.; and
the drying in step (3) is conducted at a temperature of 100° C. to 120° C. for 24 h to 48 h.

8. The method for preparing the hydrated salt composite for thermochemical heat storage according to claim 5, wherein the heating and stirring in step (4) is conducted at a temperature of 60° C. to 70° C. for 4 h to 6 h, and
the cooling and stirring in step (4) is conducted at a temperature of 10° C. to 20° C. for 1 h to 2 h.

9. (canceled)

10. A method for constructing a hydrated salt thermochemical heat storage model, comprising:
combining sensible heat and latent heat of the hydrated salt composite for thermochemical heat storage according to claim 1 into an apparent specific heat capacity, and
regards the thermochemical heat storage process as a quasi-linear process related to an initial temperature, a final temperature, a decomposition enthalpy, and a real-time temperature of thermochemical decomposition.

11. The method for preparing the hydrated salt composite for thermochemical heat storage according to claim 5, wherein the thermal-conductivity porous adsorption carrier is one selected from the group consisting of hydrophilically modified expanded graphite, hydrophilically modified silicon nitride, and hydrophilically modified silicon carbide.

12. The method for preparing the hydrated salt composite for thermochemical heat storage according to claim 5, wherein the hydrated salt heat storage material is a mixed salt of disodium hydrogen phosphate dodecahydrate and sodium acetate trihydrate, with the disodium hydrogen phosphate dodecahydrate accounting for 90% to 98% by mass and the sodium acetate trihydrate accounting for 2% to 10% by mass.

13. The method for preparing the hydrated salt composite for thermochemical heat storage according to claim 5, wherein the reinforcing material is one or more selected from the group consisting of a carbon fiber, an alumina fiber, an aluminum nitride fiber, alumina particles, and a graphite powder.
